(19) United States
(12) Patent Application Publication
(10) Pub. No.: US 2022/0270035 A1
(43) Pub. Date: Aug. 25, 2022

(54) GLOBAL MONITORING SYSTEM FOR CRITICAL EQUIPMENT PERFORMANCE EVALUATION

(71) Applicant: ConocoPhillips Company, Houston, TX (US)

(72) Inventors: Stephen T. BARTELL, Houston, TX (US); Gary A. RICHARDSON, Darwin (AU); Carl J. RYDLAND, Houston, TX (US)

(21) Appl. No.: 17/668,191

(22) Filed: Feb. 9, 2022

Related U.S. Application Data
(63) Continuation-in-part of application No. 17/108,848, filed on Dec. 1, 2020.
Application No. 17/108,848 is a continuation of application No. 15/274,655, filed on Sep. 23, 2016, now Pat. No. 10,853,762.
Application No. 15/274,655 is a continuation-in-part of application No. 15/003,414, filed on Jan. 21, 2016, now abandoned.
(60) Provisional application No. 62/222,561, filed on Sep. 23, 2015.
(60) Provisional application No. 62/106,020, filed on Jan. 21, 2015.

(51) Int. Cl. G06Q 10/08; H04L 67/12

(52) U.S. Cl. CPC G06Q 10/087; H04L 67/12

(57) ABSTRACT

The present disclose provides systems and methods relating to monitoring facility equipment at disparate locations using a host system accessible to approved devices connected to an enterprise network, as well as understanding an availability and reliability of the equipment.

### CROSS-REFERENCE TO RELATED APPLICATIONS

The present application is a continuation-in-part of U.S. patent application Ser. No. 17/108,848 filed on Dec. 1, 2020, which is a continuation of U.S. patent application Ser. No. 15/274,655 filed on Sep. 23, 2016 and now U.S. Pat. No. 10,853,762, which claims priority to U.S. Provisional Patent No. 62/222,561 filed on Sep. 23, 2015. The present application is further a continuation-in-part of U.S. patent application Ser. No. 15/003,414 filed on Jan. 21, 2016, which claims priority to U.S. Provisional Patent No. 62/106,020 filed Jan. 21, 2015. Each of these application is specifically incorporated by reference in its entirety herein.

### FIELD

The presently disclosed technology relates to monitoring facility equipment at disparate locations using a host system accessible to approved devices connected to an enterprise network and to understanding an availability and reliability of the equipment.

### BACKGROUND

Large businesses may include various business units based around the globe. Some or all of the business units may operate equipment and systems that are economically vital or critical to the parent business. Sudden unexpected shutdown of such equipment and associated systems may prove to be detrimental to the parent business. Hence, parent businesses would appreciate developments in apparatus and methods that would prevent or limit unplanned shutdowns of critical equipment.

For these reasons and others, monitoring of equipment in various facilities is desirable. Data associated with efficiency of individual pieces of equipment operating in the facility is useful. The data may be used to calculate industry standardized efficiency values, such as reliability and availability of the equipment being used. To calculate such values, it is necessary to know why certain equipment was not functioning for certain periods of time. Commonly, an operator such as a reliability engineer spends time going over logs of a previous time period to identify all hours that equipment was not functioning properly. To summarize the data for efficiency calculation purposes, the operator must then cross-check all available logs for the equipment in question to assign a reason why the equipment was not functioning. This is clearly a time-consuming effort and often results in conjecture by the operator. Exacerbating the problem is the fact that data may be missing from the logs and people are left to rely on memory over a period of weeks to recall the reason for the non-functioning status. Consequently, the output of the work is prone to decreased accuracy.

It is with these observations in mind, among others, that various aspects of the present disclosure were conceived and developed.

### SUMMARY

Implementations claimed herein address the forgoing by providing systems and methods for equipment management. In one implementation, sensor data is obtained at a business unit historian processing system. The sensor data is captured using at least one sensor and corresponds to parameters for equipment. Equipment labels are obtained for the equipment. The equipment labels include a general description and a specific description. The general description is shared among a plurality of equipment including the equipment, and the specific description is more specific than the general description. The sensor data and the equipment labels are obtained at a host processing system via an enterprise network. An equipment evaluation is generated using the host processing system. The equipment evaluation is generated based on the sensor data and equipment data. The equipment data is obtained via the enterprise network from an outside business processing system unaffiliated with the host processing system. A request is received regarding the equipment. The request includes at least one of the general description or the specific description. At least one of the sensor data, the equipment data, or the equipment is output evaluation in response to the request.

In another implementation, an operational status of equipment of a facility is received, and a visual output specifying the operational status of the equipment is generated. An interruption of function of the equipment is classified as one of a planned outage classification, a forced outage classification, and standby mode classification. A reliability of the equipment is determined by generating a reliability percentage of the equipment. The reliability percentage is generated based on a total amount of time the equipment is classified as the forced outage classification. An availability of the equipment is determined by generating an availability percentage of the equipment. The availability percentage is generated based on a total amount of time classified as the forced outage classification and the planned outage classification. The facility is monitored based on the reliability and the availability of the equipment.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates a plurality of pieces of equipment of an example facility and an operational status of the equipment generated by an example monitoring system.

FIG. 2 illustrates the monitoring system providing a reliability and an availability of the equipment.

FIG. 3 shows example operations for equipment management.

FIG. 4 depicts an example facility of a global monitoring system.

FIG. 5 illustrates an example global monitoring system.

FIG. 6 shows an example turbine machine management system.

FIG. 7 illustrates a network environment implementing the global monitoring system.

FIG. 8 depicts an example block diagram showing a monitoring process by the global monitoring system.

FIG. 9 depicts an example block diagram showing various processes implemented by the global monitoring system.

FIG. 10 shows example operations for equipment management.

### DETAILED DESCRIPTION

Aspects of the present disclosure involve systems and methods for equipment management. In one aspect, a global monitoring system is operated by a parent business for aggregating and evaluating equipment data from a plurality of distributed business units. The global monitoring system drives improvement in the operating performance of business unit facilities through interactive decision support of their critical equipment. This monitoring system is enabled through a “host” attached to an enterprise network of the parent business and is linked to each business unit facility's data historian. The host may be configured to output graphical user interfaces (GUIs) on a display facilitating access to client services and internal reporting data bases. It enables the global monitoring system to function as a collaborative platform for the purpose of analyzing and improving facility and equipment performance.

The global monitoring system can generate facility and equipment performance indicators by processing input variables from each business unit's data historian. These indicators can display performance trends and identify value improvement opportunities for facilities and their equipment. GUI programming allows enterprise-wide web access to these indicators to promote collaboration among the business units and central functions and to leverage best practices in use by the business units.

The global monitoring system can drive increased proficiency in three fundamental areas of equipment performance assurance to address performance gaps and improve equipment operation. The three fundamental areas are: (1) anomaly recognition—identifying unusual equipment operation to understand and mitigate potential failure modes; (2) performance analysis—modeling equipment operation in comparison to its nameplate capacity to diagnose and characterize performance degradation; and (3) condition monitoring—field verification of critical indicators in comparison to established limits of reliable operation.

Further, the global monitoring system can access in-house systems and commercially available client services performed by outside businesses for collaborative viewing and interaction through global monitoring to drive proficiency in each of the three fundamental areas in the business units' systems.

In one example method, equipment operated by a plurality of business units is managed through monitoring, optimization, adjustment, and/or the like. The method may comprise: sensing parameters of the equipment using a sensor to provide sensor data; receiving the sensor data using a plurality of business unit historian processing systems, each business unit historian processing unit being associated with each of the business units in the plurality of business units and configured to label equipment being monitored by the sensor with a general description and a specific description that is more specific than the general description; transmitting the sensor data to a host processing system via an enterprise network of a parent business of the plurality of business units; transmitting equipment data from an outside business processing system of an outside business that is not affiliated with the parent business to the host processing system via the enterprise network; aggregating (i) the sensor data received from each of the business unit historian processing systems associated with each of the business units and (ii) the equipment data into a data base using the host processing system; evaluating the sensor data and the equipment data using the host processing system to provide an equipment evaluation for the equipment associated with each business unit using the host processing system; receiving a request, using the host processing system, for the sensor data, the equipment data, and the equipment evaluation associated with specific equipment at a specific business unit from a user using a user interface that implements a graphical user interface (GUI), the GUI comprising an image mimicking the equipment, the user processing system comprising a search engine configured to search for monitored equipment using at least one of the general description and the specific description; and transmitting the sensor data, the equipment data, and the equipment evaluation associated with the specific equipment at the specific business unit to the user processing system in accordance with the request.

A global monitoring system for aggregating and evaluating data of equipment operated by a plurality of business units may be provided. In one example, the system comprises: a plurality of sensors configured to sense parameters of the equipment to provide sensor data; a plurality of business unit historian processing systems configured to receive the sensor data, each business unit historian processing system being associated with each of the business units in the plurality of business units and configured to label equipment being monitored by the sensor with a general description and a specific description that is more specific than the general description; an enterprise network of a parent business of the plurality of business units, the enterprise network being configured to communicate with the plurality of business unit historian processing systems; a host processing system in communication with the enterprise network and configured to receive the sensor data from each of the business unit historian processing systems and equipment data from an outside processing system of an outside business that is not affiliated with the parent business; a user processing system in communication with the host processing system via the enterprise network and comprising a graphical user interface (GUI), the GUI comprising an image mimicking the equipment, the user processing system comprising a search engine configured to search for monitored equipment using at least one of the general description and the specific description; wherein the host processing system is further configured to: aggregate (i) the sensor data received from each of the business unit historian processing systems associated with each of the business units and (ii) the equipment data into a data base; evaluate the sensor data and the equipment data to provide an equipment evaluation for the equipment associated with each business unit using the host processing system; receive a request for the sensor data, the equipment data, and the equipment evaluation associated with specific equipment at a specific business unit from a user using the user processing system; and transmit the sensor data, equipment data, and equipment evaluation associated with the specific equipment at the specific business unit to the user processing system in accordance with the request.

In some examples, the sensor data may be transmitted to the outside business processing system, wherein the outside business processing system evaluates the sensor data and provides an outside equipment evaluation as the equipment data. Additionally, evaluation may include comparing the sensor data or the equipment data to a threshold value. Alert signals may be initiated if the sensor data or the equipment data exceed a threshold value. The alert signal may also be transmitted to the user processing system.

A work order to repair or service the equipment may be generated corresponding to the sensor data or the equipment data if the sensor data or the equipment data exceed the threshold value. Additionally, the work order may be transmitted to the business unit having the equipment corresponding to the sensor data or the equipment data. The equipment corresponding to the sensor data or the equipment data may be repaired in accordance with the work order.

Business unit historian processing systems may be updated with latest sensor data and latest equipment data in real time. Further, the general description may include a function of the corresponding equipment and the specific description may comprise a make and model of the corresponding equipment.

A search of the business unit historian processing system may be performed using a search engine in the host processing system in response to a request by a user using the user processing system. The enterprise network may be configured to transmit the sensor data to the outside business processing system, wherein the outside business processing system evaluates the sensor data and provides an outside equipment evaluation as the equipment data.

The host processing system may be configured to compare the sensor data or the equipment data for specific equipment to a threshold value. In addition, the host processing system may be configured to initiate an alert signal if the sensor data or the equipment data for specific equipment exceeds the threshold value. The host processing system may also be configured to transmit the alert signal to the user processing system. The host processing system may initiate a work order to repair or service the specific equipment corresponding to the sensor data or the equipment data if the sensor data or the equipment data exceeds the threshold value. Finally, the host processing system may transmit the work order to the business unit having the specific equipment corresponding to the sensor data or the equipment data.

Additionally, as detailed herein, the presently disclosed technology manages equipment in a facility for accurate and reliable recordation of the data obtained from monitoring. The data obtained is also useful for calculating reliability and availability according to industry standardized formulas. In one aspect, a method of determining availability and reliability of facility equipment is provided. The method includes monitoring an operational status of a piece of equipment of a facility. The method also includes outputting a visual display illustrating the operational status of the equipment, wherein the operational status is categorized into a plurality of categories, at least one of the plurality of categories requiring an operator to classify an interruption of function of the equipment as one of a planned outage, a forced outage, and a standby mode. The method further includes calculating a reliability percentage of the equipment based on a total amount of time classified as the forced outage. The method yet further includes calculating an availability percentage of the equipment based on a total amount of time classified as the forced outage and the planned outage.

In another example, a method of determining availability and reliability of facility equipment includes monitoring an operational status of a piece of equipment of a facility. The method also includes outputting a visual display illustrating the operational status of the equipment, wherein the operational status is categorized into a first category, a second category and a third category, the first category comprising a functioning status of the equipment, the second category comprising a currently functioning and recently interrupted functioning status of the equipment, and the third category comprising a non-functioning status of the equipment. The method further includes prompting an operator to classify an interruption of function of the equipment as one of a planned outage, a forced outage, and a standby mode, in the event of the equipment being categorized as the second category or the third category. The method yet further includes classifying the interruption of function of the equipment by interacting with the visual display.

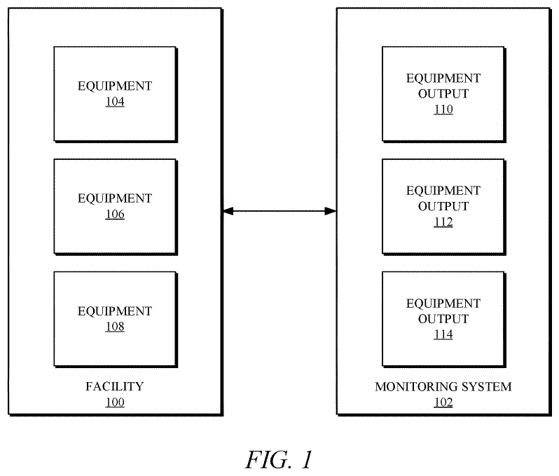

Turning to FIG. 1, a facility 100 is represented in a simplified manner with a one or more pieces of equipment (e.g., equipment 104, equipment 106, and equipment 108). A large number of types of facilities that may benefit from the presently disclosed technology are contemplated. For example, the facility 100 may be a well facility associated with the exploration, extraction and/or production of hydrocarbons, such as oil and gas. Additionally, the facility 100 may be a power plant. These are merely illustrative embodiments of the facility 100, and it is to be understood that any facility that has powered, running equipment may form all or part of the facility 100. A monitoring system 102 monitors the equipment 104-108 of the facility 100. The equipment 104-108 monitored will vary depending upon the particular facility in which it is employed. As used herein, “equipment” refers to systems, sub-systems, assemblies, sub-assemblies, or individual components. For example, the equipment 104-108 may refer to rotating equipment. In one non-limiting example, the equipment 104-108 may include a compressor, a pump, a generator, a turbine, and/or the like.

In the illustrated example of FIG. 1, three pieces of equipment are shown, but it is to be appreciated that more or less equipment may be monitored by the system 102. Each piece of equipment 104-108 is in operative communication with the monitoring system 102 in a wired and/or wireless manner. The monitoring system 102 may include one or more processing devices that are configured to receive and transmit data and perform a variety of tasks.

The monitoring system 102 may include a display that displays information related to each of the pieces of equipment 104-108, such as equipment output 110-114. The equipment output 110-114 may be a visual output associated with each of the respective pieces of equipment 104-108. For example, the first output 110 is associated with the first piece of equipment 104, the second output 112 is associated with the second piece of equipment 106, and the third output 114 is associated with the third piece of equipment 108. The equipment outputs 110-114 vary depending upon an operational status of the pieces of equipment 104-108. More precisely, the monitoring system 102 categorizes the operational status of the equipment 104-108 individually into a plurality of categories. For example, three categories may be included. A first category relates to a functioning status of the piece of equipment. A piece of equipment is categorized in this category when the piece of equipment is functioning properly and has not shown signs of non-functional operation. A second category relates to a piece of equipment that is functioning, but that been observed to be recently in a non-functioning state. A third category relates to a piece of equipment that is currently in a non-functioning state.

The equipment output 110-114 associated with each of the respective categories may be any visual output that allows a human operator to easily and confidently identify which of the categories the associated piece of equipment is currently in. In other words, any visual prompt in the form of text and/or graphics may be used to differentiate the categories. In one implementation, the visual outputs are color-coded to signify the category to the operator, such that each category of operational status is identified by a unique color. For example, the first category may be identified with a green light, the second category may be identified with a yellow light, and the third category may be identified with a red light. This color combination has been found to be a reliable combination based on a human's intuition associated with these colors.

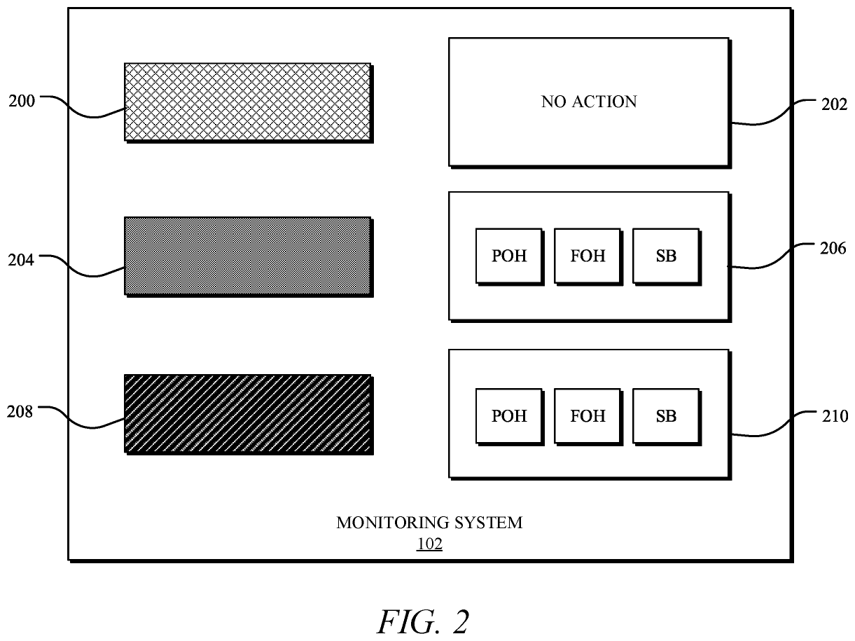

Referring to FIG. 2, the equipment outputs 110-114 may be presented as visual indicators 200, 204, and 208, which are distinguished in the illustration as distinct patterns to generally represent any differentiating visual outputs, such as the color-coded display described in detail above. The type of visual indicator 200, 204, and 108 displayed to the operator indicates the operational status of each piece of equipment being monitored, as described above. This information dictates whether action is required by the operator. In the example of FIG. 2, the first visual indicator 200 is displaying an output (e.g., green light) associated with the first category 202 of operational status. This informs the operator that no action is required based on the fully functioning status of the first piece of equipment 104. The second visual indicator 204 is displaying an output (e.g., yellow light) associated with a second category 206 of operational status. This informs the operator that, although the second piece of equipment 106 is currently running, the equipment 106 recently experienced downtime and the reason for that downtime has not yet been input into the system 102. The third visual indicator 208 is displaying an output (e.g., red light) associated with a third category 210 of operational status. This informs the operator that the third piece of equipment 108 is currently non-functioning and the reason for the downtime has not yet been input into the system 102.

Continuing with the above-described example, the visual indicator 200 associated with the first category 202 of operational status requires no action by the operator, as noted above. An additional display in the form of a separate window or the like may be displayed to confirm that no action is needed. The second and third categories 206 and 210 of operational status require action by the operator. In the current example, the second visual indicator 204 and the third visual indicator 206 display outputs (e.g., yellow light and red light) associated with the second and third categories 206 and 210, respectively. Upon viewing these indicators, the operator is aware that action is required and the system 102 thereby prompts such action. The operator determines the reason for the non-functioning status of the respective piece of equipment 104-108 and takes action to input a classification of the reason into the monitoring system 102.

The operator classifies the reason for the non-functioning status of the equipment 104-108 into one of three classifications. The first classification is represented by “POH” in the example of FIG. 2. This classification represents planned outage hours and represents the amount of time that a piece of equipment was non-functioning due to a planned outage activity, such as planned maintenance, for example. The second classification is represented by “FOH” in the illustrated example. This classification represents forced outage hours and represents the amount of time that a piece of equipment was non-functioning due to an unplanned activity. The third classification is represented by “SB” in the illustrated example. This classification represents a standby mode where the equipment is not needed at the moment.

The operator inputs the determined classification by interacting with the monitoring system 102. In one example, this includes interacting directly with a visual display of the monitoring system 102. This may be done by physically touching a screen if the visual display is a touch screen. Alternatively, a computer mouse may be employed to scroll and “click” to achieve the inputs. Certain pop-up windows showing the categories 202, 206, and 210 may be provided when the operator interacts with the respective equipment outputs 110-114. The pop-up windows may provide more detailed information about the associated piece of equipment 104-108. Such information may relate to a detailed catalogue of information for all of the periods of downtime over a predetermined period of time. For example, the information may contain a list of the recent downtime periods and the determined classifications of the reasons for the downtime periods.

The significance of the collection of this data, particularly the breakdown into the three classifications described above, relates to the ability to accurately calculate the reliability and availability of the monitored equipment 104-108 of the facility 100. Industry standardized formulas contain variables that represent the planned outage time and the forced outage time. In particular, the reliability percentage of a piece of equipment is calculated as follows:

R(%)=PH−FOHPH*100 (Equation 1)

The availability percentage of a piece of equipment is calculated as follows:

A(%)=PH−(FOH+POH)PH*100 (Equation 2)

In the above-described formulas, the following are definitions of the variables: R (reliability): the probability that equipment will not be in a forced outage condition at a point in time; A (availability): the probability that equipment will be usable at a point in time; PH (period hours): the number of hours in a time period in question; FOH (forced outage hours): the number of hours equipment was not running due to an unplanned event; and POH (planned outage hours): the number of hours equipment was not running due to a planned event.

By incorporating the above-described method into the data collection effort, the planned outage time and forced outage time are reliably obtained. This is due to the elimination of an operator attempting to account for the downtime of equipment at a much later date. The method described herein efficiently determines the reason for downtime and obtains the reason into the system 102. This data is sent to a database for storage therein. The calculations of the reliability and availability may be performed prior to inputting the data into the database or subsequently.

As described above, the recording of data employed to calculate the reliability and the availability of the equipment 104-108 is done efficiently and accurately. This enables a comparison of the calculated reliability and availability to calculations made at other facilities. This allows for similar equipment to be compared across the world, regardless of the type of the facility 100 the equipment 104-108 is employed in. The comparison is more reliable based on the reduction of the human element due to the standardized recording method described herein. In particular, an operator may view the visual display of the monitoring system 102 and identify which category 202, 206, and 210 of operational status to which the equipment outputs 110-114 correspond. In the illustrated example, the color-coded identification scheme is employed using the visual indicators 200, 204, and 208, but as described above any differentiating visual prompts may be suitable. Consistent with the color-coded example, the operator determines whether the visual indicators 200, 204, and 208 are green, yellow or red, respectively. As described above, if the visual indicator 200, 204, or 208 is associated with the first category 202 (e.g., green light), no action is required and the operator simply refers back to viewing the visual display after a period of time. If the display is associated with the second or third categories 206-210 (e.g., yellow or red light), the operator classifies the outage as a planned outage, a forced outage, or a standby mode.

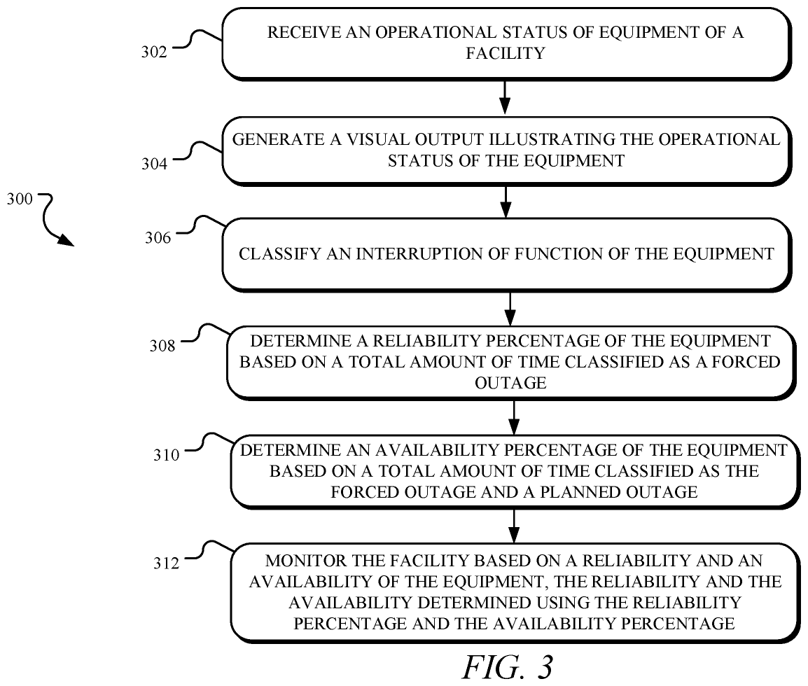

Turning to FIG. 3, example operations 300 for managing equipment are illustrated. In one example, an operation 302 receives an operational status pf equipment of a facility. The facility may be associated with production of hydrocarbons from a well, such that the operational status received from each of a pump, a generator, a compressor, and a turbine in communication with a system for monitoring the equipment. An operation 304 generates a visual output illustrating the operational status of the equipment. The output may be for presentation using a screen of a visual display of a monitoring system. The visual status illustrates the operational status of the equipment categorized into one or more of a plurality of categories. The monitoring system may classify at least one of the categories automatically. The visual output may be color-coded to display a distinct color for each of the plurality of categories of the operational status of the equipment. The plurality of categories of the operational status of the equipment may include a first category, a second category and a third category. In this example, the first category comprises a functioning status of the equipment, the second category comprises a currently functioning and interrupted functioning status of the equipment within the predetermined period of time, and the third category comprises a non-functioning status of the equipment. The visual output may be color-coded to display a green light to represent the first category, a yellow light to represent the second category, and a red light to represent the third category.

An operation 306 classifies an interruption of function of the equipment. The operation 306 may send a request to classify the interruption of function of the equipment. The request may include a detailed catalogue including any periods of downtime over a predetermined period of time for the equipment and a classification of recent downtime periods. The classification may be a planned outage, a forced outage, or a standby mode. An input may be received classifying the interruption as one of the planned outage, the forced outage, and the standby mode. An operator may classify the interruption of function may interacting with a visual display, for example by contacting a touchscreen or selecting from a pop-up window using a mouse.

An operation 308 determines a reliability percentage of the equipment based on a total amount of time classified as a forced outage, and an operation 310 determines an availability percentage of the equipment based on a total amount of time classified as the forced outage and a planned outage. The reliability percentage is calculated as a probability that the equipment will not be in the forced outage, and the availability percentage is calculated as a probability that the equipment will be usable. An operation 312 monitors the facility based on a reliability and an availability of the equipment (e.g., compressor, pump, generator, turbine, etc.). The reliability and the availability are determined using the reliability percentage and the availability percentage. The reliability percentage and the availability percentage may be input into a database. In some examples, the reliability percentage and the availability percentage are compared to an alternate facility reliability percentage and availability percentage.

In one example, the operational status of a plurality of pieces of the equipment are monitored at the facility, and the visual output illustrating the operational status of each of the plurality of pieces of the equipment is generated. A plurality of reliability percentages for the plurality of pieces of the equipment and a plurality of availability percentages for the plurality of pieces of the equipment are calculated. The maintenance for one or more of the plurality of pieces of equipment of the facility is adjusted accordingly.

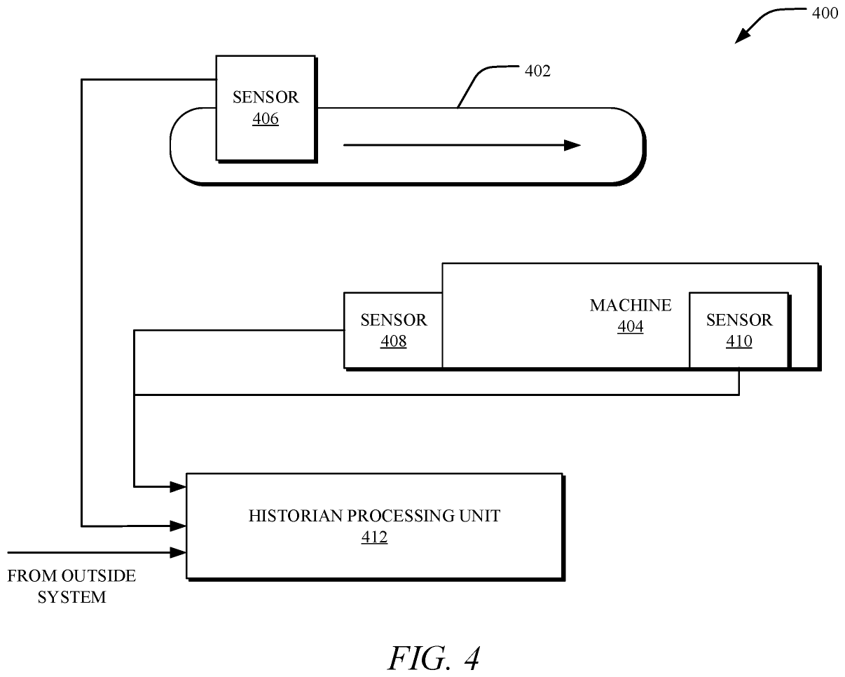

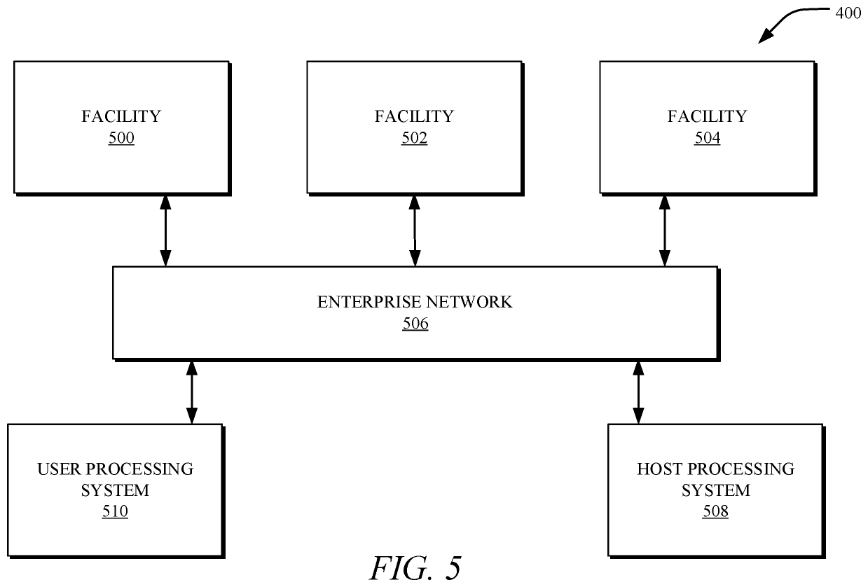

Turning to FIGS. 4-5, aspects of an example global monitoring system 400 operated by a parent business are depicted. Referring to FIG. 4, a simplified drawing of an example monitored process 402 and an example monitored machine 404 is presented. The monitored process 402 involves a first sensor 406 coupled to process piping for monitoring a fluid disposed in the piping. The first sensor 406 is configured to sense a property of interest of the fluid. Non-limiting examples of the sensed property include temperature, pressure, flow rate, density, viscosity, radiation, and/or chemical composition. A second sensor 408 and/or a third sensor 410 is coupled to the machine 404 for monitoring a property of the machine 404. Non-limiting examples of the sensed property of the machine 404 include mechanical properties such as temperature, vibration or acceleration, oil level, coolant level, speed, and/or electrical properties such as current and voltage. Sensed property values from the sensors 406-410 are transmitted to a processing system (e.g., a historian processing unit 412 at the business unit (BU) level, which may be referred to as business unit historian processing system (BUHPS)). At the BUHPS 412, the sensed property values are stored along with a time at which the sensed values were received. It can be appreciated that the sensed property values may be transmitted in real time (e.g., as soon as the measurement is performed) to the BUHPS 412. The BUHPS 412 may also label sensed data with a general description, such as compressor or pump for example, and a specific description, such as make and model of the equipment being monitored. In general, the specific description contains more specific detail regarding the monitored equipment than the general description. This enables various levels of searches to suit the requirements of a user.

Turning to FIG. 5, three facilities 500-504 are illustrated for teaching purposes, though additional or fewer facilities may be included in the global monitoring system 400. In one example, each of the facilities includes the corresponding BUHPS 412. The BUHPS 412 receive sensed property values from monitored equipment. In general, the business units associated with the BUHPS's 412 are differentiated by their geographical location. Each of the BUHPS's 412 is connected to an enterprise network 506. The enterprise network 506 in general is operated by the parent business of the business units. Communications with the enterprise network 506 may be by way of the Internet, a parent business intranet, hardwire, telephone line, radio or any other ways known in the art. Also connected to the enterprise network 506 is a host processing system 508 and a plurality of user processing systems 510. The host processing system 508 is configured to retrieve data from each of the BUHPS's 412 for the facilities 500-504. In addition, the host processing system 508 is configured to receive data from an outside business processing system operated by an outside business to evaluate specific processes and machines at specific business units. In general, the outside business is not part of or affiliated with the parent business and may perform “client services” using proprietary algorithms or techniques under contract to the parent business or one of the business units. In some examples, the outside business may communicate with the host processing system 508 using the Internet. Further, the host processing system 508 is configured to evaluate sensor data such as by comparing the sensor data to a threshold level, setpoint, or range of values. The threshold level, setpoint, or range of values may be determined by experience, by an equipment manufacturer or by an algorithm modeling the operation of a process or machine. Further, the host processing system 508 may be configured to evaluate any data or evaluations received from the outside business. In response to any evaluation, the host processing system 508 may be configured to send an alert signal to users of the business unit having the process or machine of interest or other users entered into the host processing system 508 as having an interest in the process or machine associated with the evaluation. In some examples, in response to any evaluation, the host processing system 508 may be configured to send a work order authorizing repair or servicing of the process or machine associated with the evaluation.

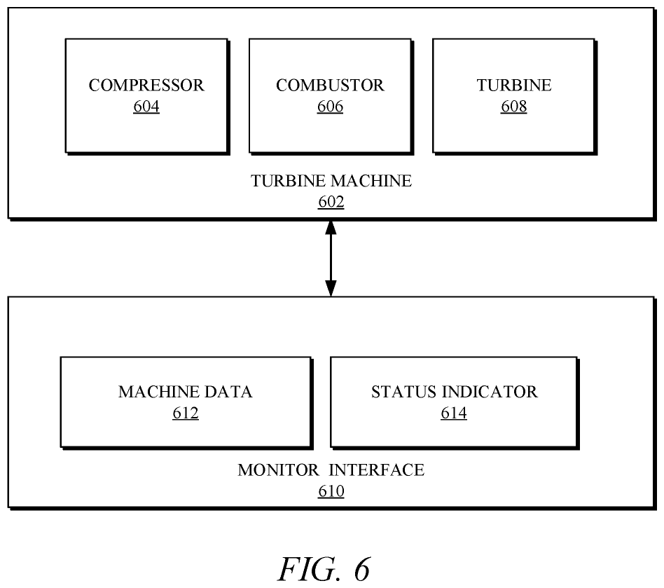

Each user processing system 510 is configured to query the host processing system 508 to request sensor values or information concerning a specific process or machine at a specific business unit. In some examples, each user processing system 510 includes a search engine to perform queries. The information may include evaluations performed by the host processing system or data or evaluations performed by an outside business. Each user processing system 510 may include a GUI to aid the user in requesting sensor values or information of interest. The GUI may provide an image that mimics the process or machine of interest with text boxes for providing data associated with a portion of interest. FIG. 6 illustrates one example of a GUI of a monitor interface 610 for a turbine machine 602 having a compressor 604, a combustor 606, and a turbine 608. The GUI of the monitor interface 610 may include machine data 612 and status indicators 614. For example, the GUI may include text boxes for displaying a label identifying the machine being monitored, data values, and units of the data values. In general, the text boxes are located in the vicinity of or connected to the portion on interest of the process or machine to which the data corresponds. In one or some examples, a color indicator is associated with each text box. The color indicator is configured to display a color corresponding to a status of the current data in the text box. As a non-limiting example, the colors may be green for normal values of the data, yellow for data values in a caution zone, and red for data values in a zone of concern. It can be appreciated that other colors may also be used for these or other purposes.

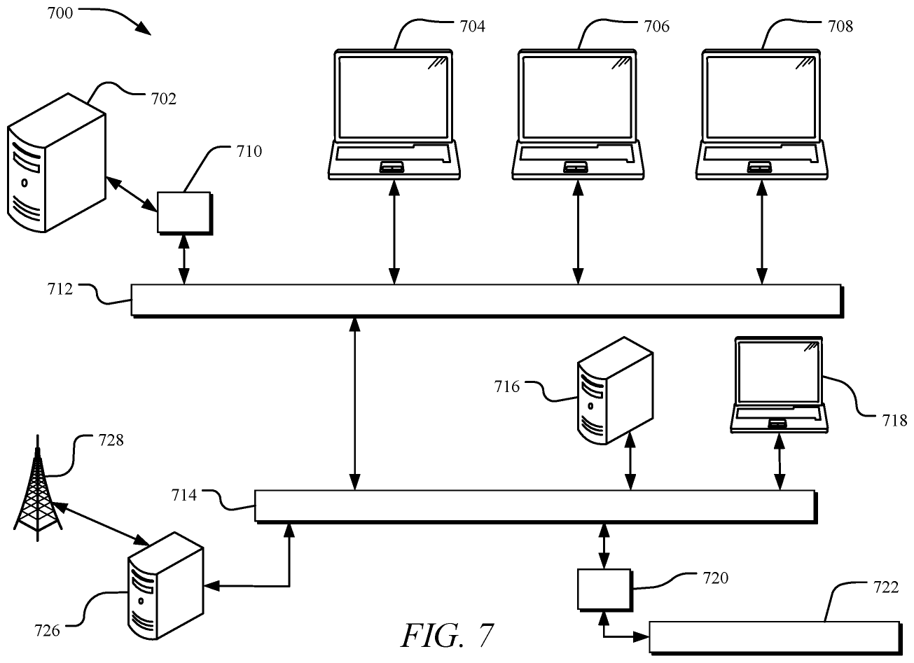

FIG. 7 depicts aspects an example network environment 700 of a global monitoring system. In this example, a host processing system 702 and a plurality of BUHPS's 704-708 are connected to an enterprise network 712. A firewall 710 may be disposed between the host processing system 702 and the enterprise network 712. Similarly, a firewall 720 may be disposed between a process control network 722 and a business unit enterprise network 714. Users at the business unit level can access the BUHPS 704-708, a BU center 718, the process control network 722, and/or the host processing system 702 via the business unit enterprise network 714 and/or the enterprise network 712. A supervisory control and data acquisition (SADA) system 726 may be used for providing sensor data to a BUHPS 704-708 or 718 for example using a radio communication system 728.

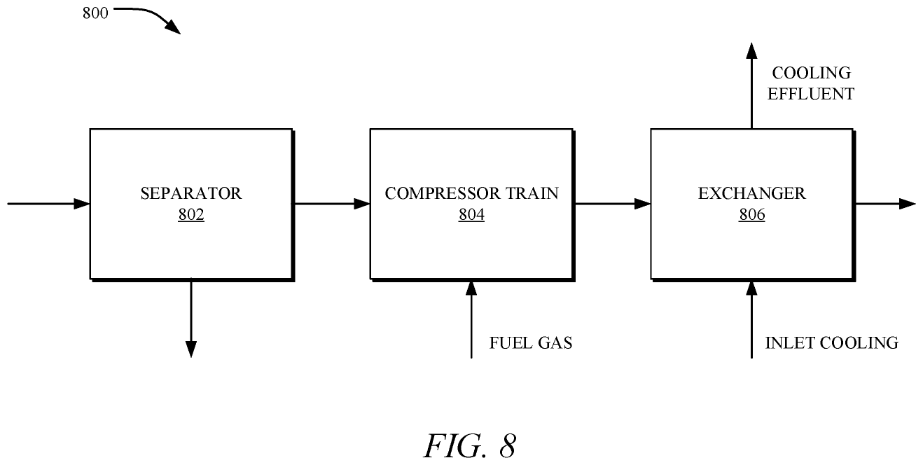

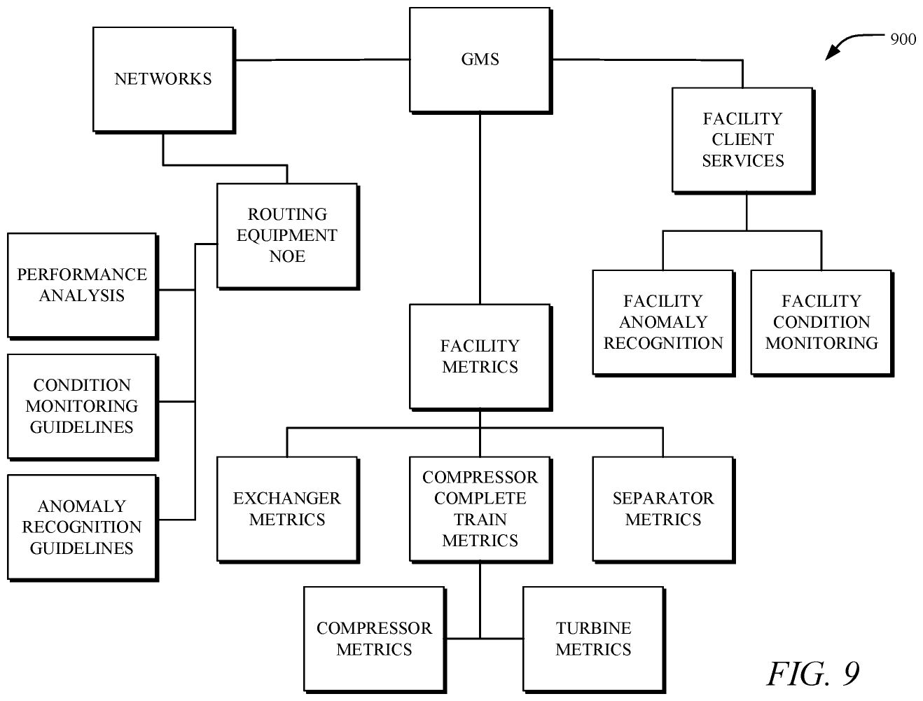

FIG. 8 is a block flow diagram of an example process 800 at a facility monitored by the global monitoring system 400. The process 800 includes a Separator 802 that supplies fluid to a Compressor Train 804 that in turn provides a fluid to Exchanger 806. Process sensors and machine sensors are used to monitor the process 800. Similarly, FIG. 9 is a process chart 900 depicting aspects of various functions of an example global monitoring system (GMS) for monitoring the process 800 illustrated in FIG. 8. The GMS performs a performance analysis of various rotating equipment for all of the business units connected to the enterprise network using condition monitoring guidelines and anomaly recognition guidelines. The GMS also monitors the metrics of the facility corresponding to the process 800 to include Exchanger performance metrics, Compressor train performance metrics to include Compressor and Turbine performance metrics.

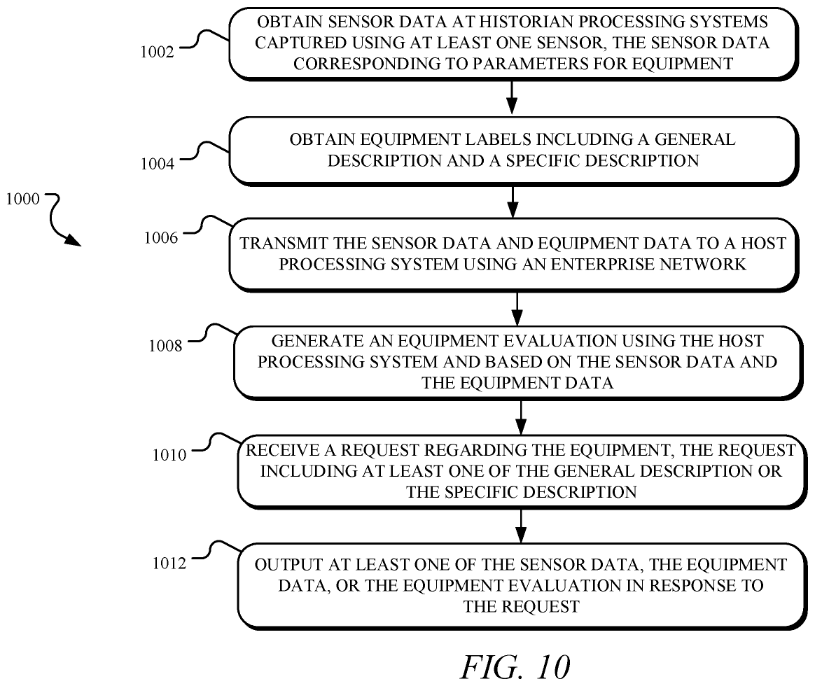

Turning to FIG. 10, example operations for equipment management are illustrated. In one implementation, an operation 1002 obtains sensor data at historian processing systems captured using at least one sensor. The sensor data corresponds to parameters for equipment. An operation 1004 obtains equipment labels including a general description and a specific description. An operation 1006 transmits sensor data and the equipment data to a host processing system using an enterprise network. An operation 1008 generates an equipment evaluation using the host processing system. The equipment evaluation is based on the sensor data and the equipment data. An operation 1010 receives a request regarding the equipment including to least one of the general description or the specific description. An operation 1012 outputs at least one of the sensor data, the equipment data, or the equipment evaluation in response to the request.

In some examples, the methods disclosed herein include aggregating and evaluating data of equipment operated by a plurality of business units. Parameters of the equipment may be sensed using a sensor to provide sensor data. The sensor data may be received using a plurality of business unit historian processing systems, with each business unit historian processing unit being associated with each of the business units in the plurality of business units and configured to label equipment being monitored by the sensor with a general description and a specific description that is more specific than the general description. In some examples, the general description includes a function of the monitored equipment and the specific description includes a make and model of the monitored equipment. Equipment data may be received from an outside business processing system of an outside business that is not affiliated with a parent business of the plurality of business units using the plurality of business unit historian processing systems. Each of the business unit historian processing systems may be updated with latest sensor data and latest equipment data in real time. The sensor data and the equipment data may be transmitted to a host processing system via an enterprise network of the parent business. The method may aggregate (i) the sensor data received from each of the business unit historian processing systems associated with each of the business units and (ii) the equipment data into a data base using the host processing system. The sensor data and the equipment data may be evaluated using the host processing system to provide an equipment evaluation for the equipment associated with each business unit using the host processing system. Evaluating may include comparing the equipment data or the other equipment data to a threshold value or a range of reference values. A request may be received using the host processing system for the sensor data, the equipment data, and the equipment evaluation associated with specific equipment at a specific business unit from a user using a user interface that implements a graphical user interface (GUI). The GUI may include an image mimicking the equipment, and the user processing system may comprise a search engine configured to search for monitored equipment using at least one of the general description and the specific description. The sensor data, the equipment data, and the equipment evaluation associated with the specific equipment at the specific business unit may be transmitted to the user processing system in accordance with the request.

Further, the sensor data may be transmitted to the outside business processing system, wherein the outside business processing system evaluates the sensor data and provides an outside equipment evaluation as the equipment data. An alert signal may be generated if the sensor data or the equipment data exceed the threshold value. The alert signal may be transmitted to the user interface. A work order may be initiated to repair or service the equipment corresponding to the sensor data or the equipment data if the sensor data or the equipment data exceed the threshold value. The work order may be transmitted to the business unit having the equipment corresponding to the sensor data or the equipment data. The method may further include repairing or servicing the equipment corresponding to the sensor data or the equipment data in accordance with the work order, and the method may further include performing a search of the business unit historian processing system using the search engine in the host processing system in response to a request by a user using the user processing system.

In support of the teachings herein, various analysis components may be used, including a digital and/or analog system. For example, the sensors, the business unit historian processing systems, the enterprise network, the host processing system, the user processing systems, the outside business processing system, and/or the like may include the digital and/or analog system. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of non-transitory computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Based upon design preferences, it is understood that the specific order or hierarchy of steps in the methods described herein can be rearranged while remaining within the disclosed subject matter. Any accompanying method claims present elements of the various steps in a sample order and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

The above specification, examples, and information provides a complete description of the structure and use of example implementations of the presently disclosed technology. Various modifications and additions can be made to the exemplary implementations discussed without departing from the spirit and scope of the presently disclosed technology. For example, while the implementations described above refer to particular features, the scope of this disclosure also includes implementations having different combinations of features and implementations that do not include all of the described features. Accordingly, the scope of the presently disclosed technology is intended to embrace all such alternatives, modifications, and variations together with all equivalents thereof.

What is claimed is:

1. A method for equipment management, the method comprising:
obtaining sensor data at a business unit historian processing system, the sensor data captured using at least one sensor and corresponding to parameters for equipment;
obtaining equipment labels for the equipment, the equipment labels including a general description and a specific description, the general description shared among a plurality of equipment including the equipment, the specific description being more specific than the general description, the sensor data and the equipment labels being obtained at a host processing system via an enterprise network;
generating an equipment evaluation using the host processing system, the equipment evaluation generated based on the sensor data and equipment data, the equipment data obtained via the enterprise network from an outside business processing system unaffiliated with the host processing system;
receiving a request regarding the equipment, the request including at least one of the general description or the specific description; and
outputting at least one of the sensor data, the equipment data, or the equipment evaluation in response to the request.

2. The method of claim 1, wherein the equipment evaluation is generated based on a comparison of at least one of the sensor data or the equipment data to a threshold value.

3. The method of claim 2, wherein an alert signal is generated if the threshold value is exceeded.

4. The method of claim 1, wherein the equipment includes one or more of a compressor, a separator, and a turbine.

5. One or more tangible non-transitory computer-readable storage media storing computer-executable instructions for performing a computer process on a computing system, the computer process comprising:
receiving an operational status of equipment of a facility;
generating a visual output specifying the operational status of the equipment;
classifying an interruption of function of the equipment as one of a planned outage classification, a forced outage classification, and standby mode classification;
determining a reliability of the equipment by generating a reliability percentage of the equipment, the reliability percentage generated based on a total amount of time the equipment is classified as the forced outage classification;
determining an availability of the equipment by generating an availability percentage of the equipment, the availability percentage generated based on a total amount of time classified as the forced outage classification and the planned outage classification; and
monitoring the facility based on the reliability and the availability of the equipment.

6. The one or more tangible non-transitory computer-readable storage media of claim 5, wherein the facility is associated with production of hydrocarbons from a well.

7. The one or more tangible non-transitory computer-readable storage media of claim 5, wherein operational status received from each of a pump, a generator, a compressor, and a turbine in communication with a monitoring system.

8. The one or more tangible non-transitory computer-readable storage media of claim 5, wherein the visual output specifying the operational status is output for presentation using a screen.

9. The one or more tangible non-transitory computer-readable storage media of claim 5, wherein the operational status is categorized into one of a plurality of categories.

10. The one or more tangible non-transitory computer-readable storage media of claim 5, wherein the plurality of categories of the operational status of the equipment comprises a first category, a second category and a third category, wherein the first category comprises a functioning status of the equipment, the second category comprises a currently functioning and interrupted functioning status of the equipment within the predetermined period of time, and the third category comprises a non-functioning status of the equipment.

11. The one or more tangible non-transitory computer-readable storage media of claim 5, wherein the interruption of function of the equipment is classified by prompting an operator with a request, the request including a detailed catalogue including any periods of downtime over a predetermined period of time for the equipment and a classification for recent downtime periods.

12. The one or more tangible non-transitory computer-readable storage media of claim 11, wherein the interruption of function of the equipment is further classified based on input received in response to the request.

13. The one or more tangible non-transitory computer-readable storage media of claim 5, wherein the reliability percentage corresponds to a probability that the equipment will not be in the forced outage category.

14. The one or more tangible non-transitory computer-readable storage media of claim 5, wherein the availability percentage corresponds to a probability that the equipment will be usable.

15. A method for equipment management, the method comprising:
receiving an operational status of equipment of a facility;
generating a visual output specifying the operational status of the equipment;
classifying an interruption of function of the equipment as one of a planned outage classification, a forced outage classification, and standby mode classification;
determining a reliability of the equipment by generating a reliability percentage of the equipment, the reliability percentage generated based on a total amount of time the equipment is classified as the forced outage classification;
determining an availability of the equipment by generating an availability percentage of the equipment, the availability percentage generated based on a total amount of time classified as the forced outage classification and the planned outage classification; and
monitoring the facility based on the reliability and the availability of the equipment.

16. The method of claim 15, wherein the facility is associated with production of hydrocarbons from a well.

17. The method of claim 5, wherein operational status received from each of a pump, a generator, a compressor, and a turbine in communication with a monitoring system.

18. The method of claim 5, wherein the visual output specifying the operational status is output for presentation using a screen.

19. The method of claim 5, wherein the operational status is categorized into one of a plurality of categories.

20. The method of claim 5, wherein the plurality of categories of the operational status of the equipment comprises a first category, a second category and a third category, wherein the first category comprises a functioning status of the equipment, the second category comprises a currently functioning and interrupted functioning status of the equipment within the predetermined period of time, and the third category comprises a non-functioning status of the equipment.
